(19) United States
(12) Patent Application Publication
(10) Pub. No.: US 2009/0192067 A1
(43) Pub. Date: Jul. 30, 2009

(54) AQUEOUS LAUNDRY DETERGENT COMPOSITIONS HAVING IMPROVED SOFTENING AND ANTISTATIC PROPERTIES

(75) Inventors: Maurice O. Dery, Putnam Valley, NY (US); Andrew Soliman, New Rochelle, NY (US); John P. Bell, Ossining, NY (US)

Correspondence Address: AKZO NOBEL INC., LEGAL & IP, 120 WHITE PLAINS ROAD, SUITE 300, TARRYTOWN, NY, 10591, US

(73) Assignee: Akzo Nobel N.V., Arnhem (NL)

(21) Appl. No.: 12/302,912

(22) PCT Filed: May 31, 2007
(86) PCT No.: PCT/EP2007/004826

§ 371 Date: Dec. 1, 2008

Related U.S. Application Data
(60) Provisional application No. 60/809,576, filed on May 31, 2006.

(51) Int. Cl. C11D 3/32

(52) U.S. Cl. 510/330

(57) ABSTRACT

The invention relates to aqueous, 2-in-1 laundry detergent compositions comprising conventional cleaning agents and at least one softening agent that comprises at least one amido alkyl amine quaternary compound. The 2-in-1 laundry detergent composition of the invention is phase stable and provides excellent cleaning performance and superior through-the-wash-softening and antistatic properties.

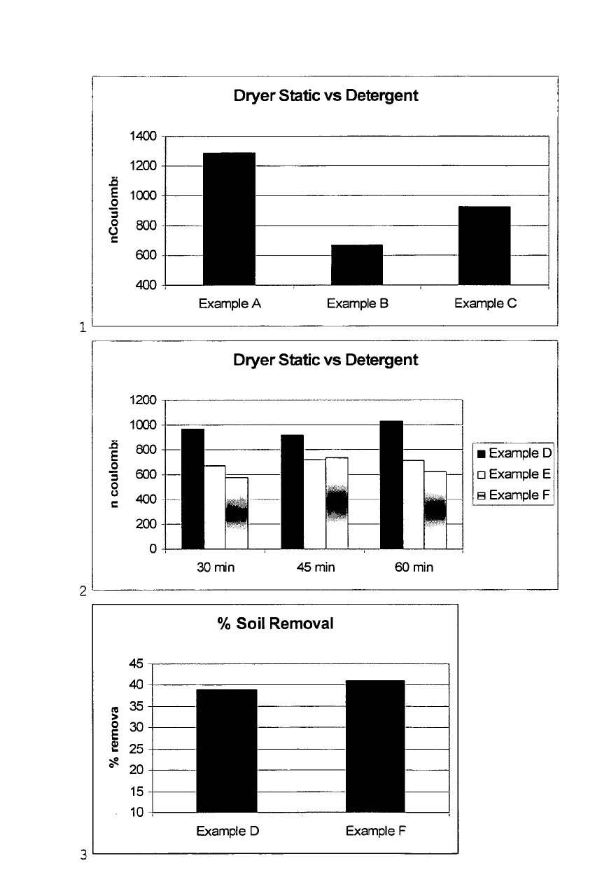

### FIELD OF THE INVENTION

The present invention generally relates to the use of amido alkyl amine quaternaries as softening-through-the-wash and antistatic agents.

### BACKGROUND OF THE INVENTION

The prior art is filled with attempts to formulate laundry detergent compositions that have good cleaning properties together with textile softening properties so as to avoid the necessity of using a separate rinse-added textile softener product in addition to the usual laundry detergent. Such products are often referred to as 2-in-1 laundry detergents. Since cleaning by definition involves the removal of unwanted material from the textile surface and textile softening normally involves deposition of softening agent onto the same surface, these attempts have typically required a compromise in formulation between cleaning and softening performance.

Cationic surfactants have long been known as useful additives in laundry detergent compositions for the purpose of providing laundered textiles with a softening, static control and/or sanitization benefit. Attempts to formulate aqueous laundry detergent compositions containing anionic surfactants and a cationic surfactant, such as a quaternary ammonium salt, for softening-through-the-wash and static control benefits have resulted in poor physical product characteristics including phase split and/or poor fabric cleaning performance.

U.S. Pat. Nos. 5,466,394 and 5,622,925 to Procter and Gamble both disclose a heavy duty liquid detergent composition containing certain levels of anionic surfactants and a quaternary ammonium fabric softening active. The preferred quaternary ammonium active is lauryl trimethyl ammonium chloride. It believed that the invention disclosed in this application offers superior performance benefits over that in 5,466,394 and 5,622,925.

Therefore, it is an object of the present invention to provide a 2-in-1 laundry detergent composition which provides excellent through-the-wash-cleaning, along with softening and anti-static benefits.

It has now been found that aqueous, 2-in-1 laundry detergent compositions comprising anionic cleaning agents and softening agents can be formulated which provide through-the-wash-softening and antistatic benefits, excellent cleaning performance, and are phase stable. More specifically, it has been found that amido alkyl amine quaternaries, when employed in typical laundry detergent formulations, provide excellent through-the-wash-softening and antistatic properties.

### SUMMARY OF THE INVENTION

The present invention generally relates to the use of amido alkyl amine quaternaries as through-the-wash-softening and antistatic agents. More specifically, the present invention relates to aqueous, 2-in-1 laundry detergent compositions comprising conventional cleaning agents and at least one softening agent that is an amido alkyl amine quaternary compound. The 2-in-1 laundry detergent composition of the invention is phase stable, provides excellent cleaning performance and superior through-the-wash-softening and antistatic properties.

### DETAILED DESCRIPTION OF THE INVENTION

In accordance with the present invention, it has been found that stable, aqueous, 2-in-1 laundry detergent compositions that provide excellent cleaning performance and superior through-the-wash-softening and antistatic properties can be prepared. More specifically, the present inventors have found that amido alkyl amine quaternaries, when employed in typical laundry detergent formulations, provide excellent through-the-wash-softening and antistatic properties.

The stable, aqueous, 2-in-1 laundry detergent compositions herein contain a cleaning or detersive surfactant component, typically an anionic surfactant component, and an amido alkyl amine quaternary component.

### Anionic Surfactant Component

The 2-in-1 aqueous detergent compositions of the invention typically comprise from about 10% to about 40%, in another embodiment from about 15% to about 25%, by weight of the detergent composition, of an anionic surfactant component. The anionic surfactant component contains alkyl polyethoxylate sulfates and/or alkyl sulfates, and may contain other non-soap anionic surfactants, or mixtures thereof.

Useful anionic surfactants include the water-soluble salts, particularly the alkali metal, ammonium, and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates, especially those obtained by sulfating the higher alcohols (C₈-C₁₈ carbon atoms), such as those produced by reducing the glycerides of tallow or coconut oil.

Another class of useful anionic surfactants are the water-soluble salts of paraffin sulfonates containing from about 8 to about 24, in another embodiment from 12 to 18, carbon atoms; alkyl glyceryl ether sulfonates, including but not limited to ethers of C₈₋₁₈ alcohols (for example, those derived from tallow and coconut oil); alkyl phenol ethylene oxide ether sulfates containing from about 1 to about 4 units of ethylene oxide per molecule and from about 8 to about 12 carbon atoms in the alkyl group; and alkyl ethylene oxide ether sulfates containing from about 1 to about 4 units of ethylene oxide per molecule and from about 10 to about 20 carbon atoms in the alkyl group.

Still other useful anionic surfactants include the water-soluble salts of esters of α-sulfonated fatty acids containing from about 6 to 20 carbon atoms in the fatty acid group and from about 1 to 10 carbon atoms in the ester group; the water-soluble salts of 2-acyloxy-alkane-1-sulfonic acids containing from about 2 to 9 carbon atoms in the acyl group and from about 9 to about 23 carbon atoms in the alkane moiety; the water-soluble salts of olefin sulfonates containing from about 12 to 24 carbon atoms; and β-alkyloxy alkane sulfonates containing from about 1 to 3 carbon atoms in the alkyl group and from about 8 to 20 carbon atoms in the alkane moiety.

A class of preferred anionic surfactants are the alkyl sulfates and alkyl ether sulfates of the formula

RO(C₂H₄O)x SO₃⁻M⁺

wherein R is an alkyl chain having from about 10 to about 22 carbon atoms, saturated or unsaturated, and the longest linear portion of the alkyl chain is 15 carbon atoms or less on the average, M is a cation capable of making the compound water-soluble, especially an alkali metal, ammonium or substituted ammonium cation, and x is from 0 to about 15. The anionic surfactant component of the present compositions comprises from about 5% to about 40%, preferably from about 7% to about 36%, most preferably from about 10% to about 25%, by weight of the detergent composition, of alkyl sulfates and/or alkyl ether sulfates as described above.

Other preferred anionic surfactants include, but are not limited to, non-ethoxylated C₁₂₋₁₅ primary and secondary alkyl sulfates. Under cold water washing conditions, i.e. less than abut 65° F., a mixture of such ethoxylated and non-ethoxylated alkyl sulfates is especially useful. Mixtures of the alkyl sulfates with the above-described paraffin sulfonates, alkyl glyceryl ether sulfonates, and esters of α-sulfonated fatty acids are also useful.

Another useful class of anionic surfactants are those known as alkyl benzene sulfonates. These include alkyl benzene sulfonates in which the alkyl group contains from about 9 to about 15 carbon atoms, in straight-chain or branched configuration, e.g. those of the type described in U.S. Pat. Nos. 2,220,099 and 2,477,383, both of which are incorporated herein by reference.

The invention is not limited by choice of anionic surfactants and other known classes of anionic surfactants can also be usefully employed in the context of the invention.

### Amido Alkyl Amine Quaternary Surfactant

The compositions of the invention also contain from about 1% to about 10%, in another embodiment from about 2% to about 7%, and in yet another embodiment from about 3% to about 5%, by weight of an amido alkyl quaternary surfactant of the formula:

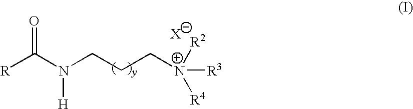

wherein

R is a saturated or unsaturated, branched or straight-chain alkyl group, in another embodiment an alkyl group of from about 6 to about 26 carbon atoms, and in still another embodiment an alkyl group of 12 to about 22 carbon atoms; with the proviso that not more than 80% of said saturated or unsaturated, branched or unbranched alkyl group has from 16 to 18 carbon atoms;

R² and R³ are each alkyl, alkoxyalkyl, hydroxyalkyl, polyalkoxy alkyl, hydroxyl alkyl sulfonate, alkyl sulfonate or alkylarylsulfonate; in another embodiment C₁-C₈ alkyl, C₁-C₈ alkoxyalkyl, C₁-C₈ hydroxyalkyl, C₁-C₈ polyalkoxy, with the degree of polymerization ranging from 2 to 30, and in still another embodiment C₁-C₄ alkyl, C₁-C₄ alkoxyalkyl, C₁-C₄ hydroxyalkyl, C₁-C₄ polyalkoxy, with the degree of polymerization ranging from 2 to 30;

R⁴ is a saturated or unsaturated hydrocarbon such as alkyl, aryl, aralkyl, alkaryl, saturated or unsaturated; in another embodiment H or a C₁-C₄ saturated or unsaturated alkyl group;

wherein any two of R², R³, and R⁴, together with the nitrogen atom to which they are attached, form a heterocyclic ring,

y is an integer from 1 to 12, in another embodiment 1 to 6, and in still another embodiment 1 to 3, and

X⁻ is a compatible anion. Suitable anions include, but are not limited to, halides, oxo ions of phosphorous, sulfur or chloride, and various organic anionic molecules.

In another embodiment the surfactant is an alkylamido propyl trialkyl ammonium quaternary compound having the following general formula:

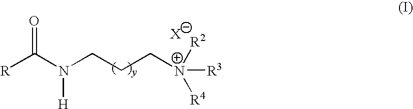

wherein R is tallowalkyl R², R³, and R⁴ are methyl, y is 1, and X⁻ is as defined above, preferably methosulfate.

This class of compounds can be prepared by quaternizing the corresponding alkylamido propyl trimethylamide with methylene chloride, ethyl chloride, benzyl chloride, vinyl chloride, butyl chloride, dimethyl sulfate, diethyl sulfate, chlorohydroxyalkylsulfonate, chloroalkylsulfonates and the like, and mixtures thereof.

The long-chain saturated or unsaturated, branched or straight-chain alkyl groups, R, are hydrophobic in nature and are generally derived from one or more fatty acids, which are reacted with an amine to form the amide. Examples of fatty acids include, but are not limited to, cetyl, oleyl, stearyl, erucyl, and derivatives of tallow, coco, soya, rapeseed oils and the like, and mixtures thereof. It is preferred that R comprise not more than 80% of said saturated or unsaturated, branched or straight-chain alkyl groups having from 16 to 18 carbon atoms, the remainder of R being selected from saturated or unsaturated, branched or straight-chain alkyl groups having from 6 to 26 carbon atoms. It is preferred that the parent fatty acids from which the R group is derived have an IV of from 20-100, in another embodiment 30-90, in another embodiment 40-80, and in still another embodiment 45-65.

In another embodiment, the quaternary ammonium salt is an amido ethyl morpholine quaternary salt of the following general structure:

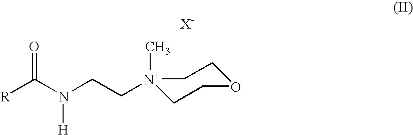

wherein R and X⁻ are as defined above. A useful surfactant corresponding to the above formula is isosteryl amido ethyl morpholine lactate.

Non-limiting examples of other useful quaternary salts include the following structures:

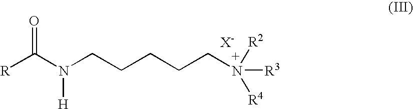

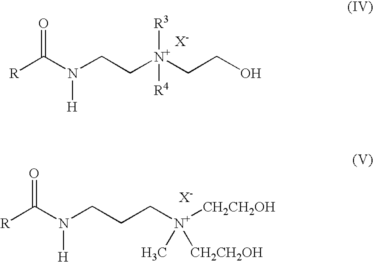

wherein R, R², R³, R⁴, and X are as defined above. Preferably, R has from about 6 to about 26 carbon atoms, more preferably from about 12 to about 24 carbon atoms. A specific example of a compound falling within structure (V) is tallowalkylamidopropyl-N-di(2-hydroxyethyl)methyl ammonium chloride.

Additional examples of useful quaternary salts include, but are not limited to, those corresponding to the following structures:

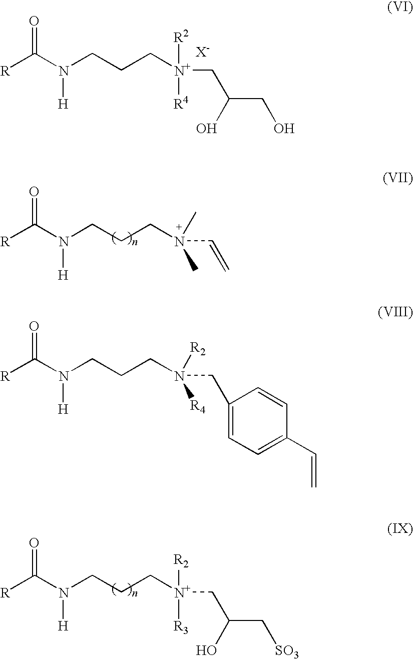

wherein R, R², R³, R⁴ are as defined above.

X may be halides, oxo ions of phosphorous, sulfur or chloride, and various organic anions, including chlorides, bromides, iodides, oxides of phosphorous, hypochlorides, phosphates, phosphates, oxides of sulfur, sulfates, sulfites, sulfonates, phosphates, acetates, carboxylates, chlorates, perchlorates, salicylates, phthalates, lactates, maleates, glycinates, citrates, citric acid, lactic acid, salicylic acid, phthalic acid, benzoic acid, naphthoic acid, amino acids, and so forth.

In an especially useful embodiment, amido propyl morpholine quaternary salts of the following general structure are employed as the cationic component:

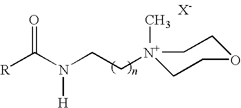

wherein R comprises not more than 80% of a saturated or unsaturated, branched or linear alkyl group having from 16 to 18 carbon atoms, and mixtures thereof, the remainder of R being selected from saturated or unsaturated, branched or straight-chain alkyl groups having from about 6 to about 26 carbon atoms and n is an integer from 1-2.

The 2-in-1 detergent composition of the invention generally comprises a weight ratio of anionic surfactant component to amido alkyl amine quaternary ammonium softening agent of from about 1:1 to about 20:1

### Fatty Acid

The 2-in-1 detergent compositions of the present invention may optionally contain from 0% to about 10%, preferably from about 2% to about 7%, most preferably from about 3% to about 5%, by weight of a fatty acid or fatty acid salt containing from about 8 to about 20 carbon atoms. The fatty acid or fatty acid salt can also contain from about 1 to about 10 ethylene oxide units in the hydrocarbon chain.

Suitable fatty acids or fatty acid salts are saturated and/or unsaturated, branched or straight-chain and can be obtained from natural sources such as plant or animal esters (e.g. palm kernel oil, palm oil, coconut oil, babassu oil, safflower oil, tall oil, castor oil, tallow and fish oils, grease, and mixtures thereof), or synthetically prepared (e.g. via the oxidation of petroleum or by hydrogenation of carbon monoxide via the Fisher Tropsch process). Examples of suitable saturated fatty acids or fatty acid salts for use in the compositions of this invention include capric, lauric, myristic, palmitic, stearic, arachidic, and behenic acid. Suitable unsaturated fatty acid species include palmitoleic, oleic, linoleic, linolenic, and ricinoleic acid. Examples of preferred fatty acids or fatty acid salts are saturated C₁₂ fatty acid, saturated C₁₂-C₁₄ fatty acids, and saturated or unsaturated C₁₂ to C₁₈ fatty acids, and mixtures thereof.

### Optional Components

The compositions of the present invention can also contain up to about 30%, preferably from about 1% to about 20%, more preferably from about 2% to about 10%, by weight of an ethoxylated nonionic surfactant. Particularly useful are ethoxylated alcohols and ethoxylated alkyl phenols of the formula

R(OC₂H₄)ₙOH,

wherein R is selected from the group consisting of aliphatic hydrocarbon radicals containing from about 8 to about 15 carbon atoms and alkyl phenyl radicals wherein the alkyl groups contain from about 8 to about 12 carbon atoms, and the average value of n is from about 5 to about 15. Ethoxylated alcohols having an average of from about 10 to about 15 carbon atoms in the alcohol and an average degree of ethoxylation of from about 6 to about 12 moles of ethylene oxide per mole of alcohol can also be advantageously employed. Surfactants such as those described above can be found in U.S. Pat. Nos. 4,284,532 and 4,285,841, which are incorporated herein by reference.

The addition of the ethoxylated nonionic surfactant to compositions of the present invention is helpful in providing physical stability to the detergent product, i.e. preventing phase splits and precipitation. In most cases, at least about 2% of the nonionic surfactant in the present detergent compositions can alleviate and/or eliminate physical stability problems.

The compositions herein also preferably contain up to about 30%, in another embodiment from about 1% to about 20%, and in still another embodiment from about 1% to about 10%, by weight of a detergent builder material. While all manner of detergent builders known in the art can be used in the present compositions, the type and level of builder should be selected such that the final composition has an initial pH of from about 7.0 to about 9.0 at a concentration of from about 1% to about 10% by weight in water at 20° C. In liquid detergent compositions, the builder preferably represents from about 1% to about 20%, in another embodiment from about 3% to about 10%, by weight of the composition. Citric acid is an example of a particularly useful builder. Other examples of builders include, but are not limited to, sodium citrate, sodium carbonate, and sodium sulfate.

Enzymes can be included in the formulations of the invention for a wide variety of fabric laundering purposes, including removal of protein-based, carbohydrate-based, or triglyceride-based stains, for example, and for fabric restoration. The enzymes to be incorporated include proteases, amylases, lipases, and cellulases, as well as mixtures thereof. Other types of enzymes may also be included. They may be of any suitable origin, such as vegetable, animal, bacterial, fungal, and yeast origin. However, their choice is governed by several factors such as pH-activity and/or stability optima, thermostability, stability versus active detergents, builders, and so on. In this respect bacterial or fungal enzymes are preferred, such as bacterial amylases and proteases, and fungal cellulases. Particularly preferred compositions herein contain from about 0.05% to about 2% by weight of detersive enzymes, especially the amylases, proteases, and mixtures thereof, of the type well known to detergent formulators.

Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01% to 1%, by weight of a commercial enzyme preparation. Protease enzymes are usually present in such commercial preparations at levels sufficient to provide from 0.005 to 0.1 Anson units (AU) of activity per gram of composition. The types of enzymes employable and the methods for effectively employing them in detergent compositions are within the area of expertise of one of ordinary skill in the art.

Optionally, the compositions herein may also contain various additional stabilizers such as, for example, borate-type stabilizers. Typically, such stabilizers will be used at levels in the compositions from about 0.25% to about 10%, preferably from about 0.5% to about 5%, more preferably from about 0.75% to about 4%, by weight of boric acid or other borate compound capable of forming boric acid in the composition (calculated on the basis of boric acid). Boric acid is preferred, although other compounds such as boric oxide, borax and other alkali metal borates (e.g. sodium ortho-, meta- and pyroborate, and sodium pentaborate) are suitable. Substituted boric acids (e.g. phenylboronic acid, butane boronic acid, and p-bromo phenylboronic acid) can also be used in place of boric acid.

Other optional components for use include, but are not limited to, neutralizing agents, buffering agents, phase regulants, hydrotropes, polyacids, suds regulants, opacifiers, antioxidants, bactericides, dyes, perfumes, brighteners, and the like. Non-limiting examples of neutralizing agents for use herein are organic bases, especially triethanolamine and monoethanol amine, which provide a better detergency performance than inorganic bases such as sodium and potassium hydroxides.

The following non-limiting examples illustrate the compositions and utility of the present invention.

### Example 1

A premium commercial heavy-duty liquid laundry detergent was purchased (Tarrytown N.Y.) and quaternary ammonium compounds were added to it in the stated proportions.

| | Example A | Example B | Example C |
|---|---|---|---|
| commercial detergent | 100% | 96% | 96% |
| lauryltrimethylammonium | | | 4% |
| chloride | | | |
| Trimethyltallowalkylamido- | | 4% | |
| propylammonium chloride | | | |

Standard laundry loads were washed in an automatic clothes washer. Each load used 0.48 cup (123 grams) of one of the above detergents compositions, providing about 1,900 PPM of the detergent composition to the wash water solution. The wash water was at 36-40° F. and the water contained 40 PPM of Ca⁺⁺:Mg⁺⁺ (3:1). After a standard wash cycle (wash, rinse, and spin) the loads were placed in standard electric clothes driers and tumble-dried. After 70 minutes of drying, a polyester swatch was removed from the standard clothes bundle and the amount of static present on this swatch was determined using a Point Simco Electrostatic Field Meter.

The averaged results from an experiment repeated in triplicate and reported as nano coulombs are given in the chart below. The data is a comparison of the static reduction of a detergent containing 4% lauryltrimethylammonium chloride vs. 4% tallowalkylamidopropyl trimethylammonium chloride vs. the commercial laundry detergent without the addition of quaternary ammonium compounds. As can be seen from the data, lower is better, the incorporation of tallowamidopropyl trimethylammonium chloride significantly reduces the build-up of static in the clothes dryer.

### Example 2

A premium commercial heavy-duty liquid laundry detergent was purchased (Tarrytown N.Y.). The brand of detergent was different from the one used in Example 1.

| | Example D | Example E | Example F |
|---|---|---|---|
| commercial detergent | 100% | 98% | 96% |
| trimethyltallowamido- | | 2% | 4% |
| propylammonium chloride | | | |

Standard laundry loads were washed in an automatic clothes washer. Each load used 0.48 cup (123 grams) of one of the above detergents compositions, providing about 1,900 PPM of the detergent composition to the wash water solution. The wash water was at 36-40° F. and contained 40 PPM of Ca⁺⁺:Mg⁺⁺ (3:1). After a standard wash cycle (wash, rinse, and spin) the loads were placed in standard electric clothes driers and tumble-dried. After 30, 45, and 60 minutes of drying, a polyester swatch was removed from the standard clothes bundle and the amount of static present on each swatch was determined using a Point Simco Electrostatic Field Meter. The charge is reported in nano coulombs.

Below is a chart comparing the static reduction of a detergent containing 4% tallowamidopropyltrimethylammonium chloride vs. the commercial laundry detergent without the addition of quaternary ammonium compounds. As can be seen from the data, lower is better, the incorporation of tallowamidopropyl trimethylammonium chloride significantly reduces the build-up of static in the clothes dryer.

### Example 3

Standard laundry loads including four terry cloth towels were washed in an automatic clothes washer. Each load used 0.48 cup (123 grams) of detergent composition A or B, providing about 1,900 PPM of the detergent composition to the wash water solution. The wash water temperature was 36-40° F. and the water contained 40 PPM of Ca⁺⁺:Mg⁺⁺ (3:1). After a standard wash cycle (wash, rinse, and spin) half of the loads were placed in standard electric clothes driers and tumble-dried. The other half of each load was placed on standard drying racks and allowed to dry at ambient conditions for at least 24 hrs. For each load, the softness of the terry cloth towels was graded manually by a panel of trained graders. The graders were asked to make a selection of preference between towels washed with either detergent A or detergent B. The towels had been dried under either “line dry” or “tumble-dried” conditions. It is clear from the results summarized in the table below that the graders preferred laundry detergents containing the compositions of the present invention.

| | % Graders Preferring Example B |
|---|---|
| Tumble Dried | 83% |
| Line Dried | 77% |

### Example 4

A variation of ASTM method D 4265 was used to determine the effect on the cleaning performance of detergents containing tallowalkylamidopropyl trimethyl ammonium quaternaries. The initial reflectance of four soiled and three unsoiled swatches was determined using a Hunter Lab Ultrascan XE spectrophotometer with a 420 nm UV filter. The fabric swatches were obtained from Testfabrics, Inc. The soiled swatches were WFK-20C and the unsoiled swatches were WFK-20A. The washing and rinsing of the swatches was performed using a Terg-O-Tometer. The wash conditions were 32° C., 120 PPM water hardness, 10 minutes with a 1,000 g wash solution. The detergent concentration in the wash water was 0.17% wt. One rinse was performed at 21° C., 120 PPM water hardness for 2 minutes with a 1,000 g rinse solution. Eight spectrophotometric readings were taken on every swatch. The detergents from Examples D and F were used. A ratio of soil removed vs. the initial soil content of the swatch was used to calculate the detergency percentage. The results are given in the table below. As is evident from the data below, incorporation of the tallowalkylamidopropyltrimethyl ammonium quaternary into the detergent formulation does not negatively impact the ability to remove soil. In this case a slightly better cleaning performance was observed. Redeposition is the property where soil is deposited onto clean fabric during the wash cycle. The redeposition performance was measured for the laundry detergents of Examples D and F and they were found to be comparable.

### Example 5

| | Example | Example | Example | Example |
|---|---|---|---|---|
| Component | G | H | I | J |
| Water % | 45.2 | 41.2 | 43.2 | 41.2 |
| NaOH 1N % | 1.8 | 1.8 | 1.8 | 1.3 |
| DDBSA % | 6.9 | 6.9 | 6.9 | 6.9 |
| Sodium lauryl ether | 23.9 | 23.9 | 23.9 | 23.9 |
| sulfate % | | | | |
| Ethoxylated alcohol % | 7.1 | 7.1 | 7.1 | 7.1 |
| Sodium citrate % | 2.4 | 2.4 | 2.4 | 2.4 |
| Sodium sulfate % | 0.3 | 0.3 | 0.3 | 0.3 |
| Sodium carbonate % | 2.0 | 2.0 | 2.0 | 2.0 |
| Ethanol % | 3.3 | 3.3 | 3.3 | 3.3 |
| Propylene glycol % | 6.9 | 6.9 | 6.9 | 6.9 |
| Trimethyltallowalkyl- | 0 | 4 | | |
| amidopropylammonium | | | | |
| methosulfate % | | | | |
| Lauryltrimethyl- | | | 2 | 4 |
| ammonium chloride | | | | |
| total | 100 | 100 | 100 | 100 |

DDBSA is Witconic ® 1298S
Sodium lauryl ether sulfate is Witcolate ® ES-1
Ethoxylated alcohol is Tomadol ® 25-7

Four laundry detergent formulations, Examples G through J, were prepared by blending the surfactants listed in the table in the disclosed weight percentages. Example I was not stable and formed a second layer on standing. Example J formed a thick gel-like phase on addition of the lauryltrimethylammonium chloride and separated into two layers on standing. Neither formulation I nor formulation J formed a clear/stable one phase solution and as a result both were deemed unsuitable to be tested as a laundry detergent.

Three standard laundry loads were washed in an automatic clothes washer. Each load used 0.48 cup (123 grams) of either detergent G or detergent H, providing about 1,900 PPM of the detergent composition to the wash water solution. The wash water was at 36-40° F. and contained 40 PPM of Ca⁺⁺:Mg⁺⁺ (3:1). After a standard wash cycle (wash, rinse, and spin) the three loads were each placed in standard electric clothes driers and tumble-dried. Every five minutes during the drying cycle, a polyester swatch was removed from the standard clothes bundle and the amount of static present on each swatch was determined using a Point Simco Electrostatic Field Meter. The charge was recorded in nano coulombs. A summation of every recorded static measurement was performed. thus giving the total charge generated during the 60-minute drying cycle. The averaged results from the three individual tests are reported in the table below. As is evident from the results, use of Example H significantly reduced the amount of static in the total drying cycle compared to Example G.

| | Total static (in nano coulombs) produced |
|---|---|
| | during a 60-minute drying cycle |
| Example G | 5,009 |
| Example H | 4,077 |

### Example 6

A premium commercial heavy-duty liquid laundry detergent was purchased (Tarrytown N.Y.). The brand of detergent was different from the one used in Example 1.

| | Example | | | | |
|---|---|---|---|---|---|
| | D | F | J | K | L |
| commercial detergent | 100% | 96% | 96% | 96% | 96% |
| trimethyltallowamido- | | 4% | | | |
| propylammonium chloride | | | | | |
| trimethylcocalkylamido- | | | 4% | | |
| propylammonium chloride | | | | | |
| trimethylerucylamido- | | | | 4% | |
| propylammonium chloride | | | | | |
| trimethylhydrogentated- | | | | | 4% |
| tallowalkylamidopropyl- | | | | | |
| ammonium methosulfate | | | | | |
| Charge after sixty minutes | 1,200 | 800 | ~1,200 | ~1,200 | 1,500 |
| (nano coulombs) | | | | | |

Standard laundry loads were washed in an automatic clothes washer. Each load used 0.48 cup (123 grams) of one of the above detergents compositions (D-L), providing about 1,900 PPM of the detergent composition to the wash water solution. The wash water was at 36-40° F. and contained 40 PPM of Ca⁺⁺:Mg⁺⁺ (3:1). After a standard wash cycle (wash, rinse, and spin) the loads were placed in standard electric clothes driers and tumble-dried. After 60 minutes of drying, a polyester swatch was removed from the standard clothes bundle and the amount of static present on each swatch was determined using a Point Simco Electrostatic Field Meter. The charge is reported in the table above in nano coulombs.

As is evident from the data in the table above, the only material that was effective in reducing the static in a clothes dryer was that derived from tallow fatty acid. Without wishing to be bound by theory, it is believed that a certain amount of unsaturation is needed in the R group of the amidopropylamine to provide suitable antistatic effects. Coco fatty acid, which typically has an IV value of 8-12, is not effective in reducing static. Unsaturation alone is not the only factor that needs to be considered, the chain length of the R group is also important. Pure chain lengths, such as eurucic, do not give favourable results in this test. Therefore, the combination of R group that is composed of no more than 80% of a single chain length and has an IV value of 20-100 is the most preferred.

1. A 2-in-1 laundry detergent composition having improved softening and anti-static properties comprising at least one anionic detersive surfactant component and at least one cationic softening agent comprising an amido alkyl amine quaternary ammonium compound of the formula: 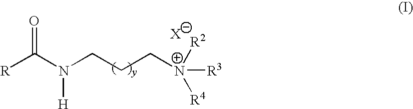
wherein
R is a saturated or unsaturated, branched or straight-chain alkyl group having an IV of from 20 to 90, wherein not more that 80% of said alkyl group has from 16 to 18 carbon atoms, the remainder of R being selected from a saturated or unsaturated, branched or straight-chain alkyl group of from about 6 to about 26 carbon atoms,
R² and R³ are each alkyl, alkoxyalkyl, hydroxyalkyl, polyalkoxy alkyl, hydroxyl alkyl sulfonate, alkyl sulfonate or alkylarylsulfonate;
R⁴ is a saturated or unsaturated hydrocarbon such as alkyl, aryl, aralkyl, alkaryl;
wherein any two of R², R³, and R⁴, together with the nitrogen atom to which they are attached, may optionally form a heterocyclic ring,
y is an integer from 0 to 12,
X⁻ is an anion, and the IV of said cationic softening agent is from 20 to 100.

2. The composition of claim 1 wherein R is a saturated or unsaturated, branched or straight-chain alkyl group having from about 6 to about 26 carbon atoms, wherein not more that 80% of said alkyl group has from 16 to 18 carbon atoms; R² and R³ are each independently selected from C₁-C₈ alkyl, C₁-C₈ alkoxyalkyl, C₁-C₈ hydroxyalkyl, C₁-C₈ polyalkoxy, with the degree of polymerization ranging from 2 to 30; R⁴ is a saturated or unsaturated alkyl, aryl, aralkyl, alkaryl group, wherein any two of R², R³, and R⁴, together with the nitrogen atom to which they are attached, may optionally form a heterocyclic ring, and X⁻ is an anion selected from halides, oxo ions of phosphorous, sulfur or chloride, compatible organic anionic molecule, or mixtures thereof, and the like.

3. The composition of claim 2 wherein R is a saturated or unsaturated, branched or straight-chain alkyl group of 12 to about 22 carbon atoms, wherein not more that 80% of said alkyl group has from 16 to 18 carbon atoms; R² and R³ are each C₁-C₄ alkyl, C₁-C₄ alkoxyalkyl, C₁-C₄ hydroxyalkyl, C₁-C₄ polyalkoxy, with the degree of polymerization ranging from 2 to 30; R⁴ is a saturated or unsaturated C₁-C₄ alkyl group, and R has an IV of from 40-65.

4. The composition of claim 1 wherein said amido alkyl amine quaternary ammonium compound comprises at least one compound of the formulae: 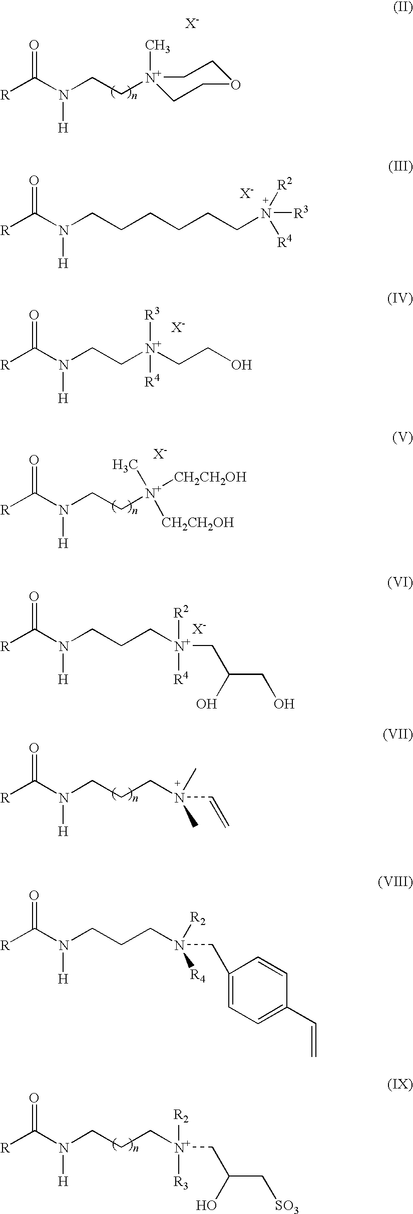
or mixtures thereof, wherein
R is a saturated or unsaturated, branched or straight-chain alkyl group of from about 6 to about 26 carbon atoms, wherein not more that 80% of said alkyl group has from 16 to 18 carbon atoms;
R² and R³ are each C₁-C₈ alkyl, C₁-C₈ alkoxyalkyl, C₁-C₈ hydroxyalkyl, C₁-C₈ polyalkoxy, with the degree of polymerization ranging from 2 to 30; and
R⁴ is a saturated or unsaturated alkyl, aryl, aralkyl, alkaryl, wherein any two of R², R³, and R⁴, together with the nitrogen atom to which they are attached, may optionally form a heterocyclic ring,
n is an integer from 1 to 12, and
X⁻ is an anion that imparts water-solubility to said quaternary ammonium compound.

5. The composition of claim 1 wherein X⁻ is selected from halides, oxo ions of phosphorous, sulfur or chloride, organic anions of chlorides, bromides, iodides, oxides of phosphorous, hypochlorides, phosphates, phosphates, oxides of sulfur, sulfates, sulfites, sulfonates, phosphates, acetates, carboxylates, chlorates, perchlorates, salicylates, phthalates, lactates, maleates, glycinates, citrates, citric acid, lactic acid, salicylic acid, phthalic acid, benzoic acid, naphthoic acid, amino acids, and mixtures thereof.

6. The composition of claim 5 wherein X⁻ is selected from halides, oxo ions of phosphorous, sulfur or chloride, organic anions of chlorides, bromides, iodides, oxides of phosphorous, hypochlorides, phosphates, phosphates, oxides of sulfur, sulfates, sulfites, sulfonates, phosphates, acetates, carboxylates, chlorates, perchlorates, salicylates, phthalates, lactates, maleates, glycinates, citrates, citric acid, lactic acid, salicylic acid, phthalic acid, benzoic acid, naphthoic acid, amino acids, and mixtures thereof.

7. The composition of claim 1 wherein said amidoalkylamine quaternary ammonium compound comprises tallow amidopropyltrimethyl ammonium quaternary salt, an amidopropylmorpholine quaternary salt, an isosteryl-amidoethyl morpholine lactate, dimethylalkylglycerolammonium chloride, amidopropylmorpholine quaternary salt, or mixtures thereof.

8. The composition of claim 2 wherein said amidoalkylamine quaternary ammonium compound is of the following structure: 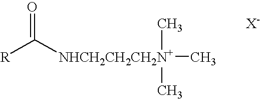
wherein R has an IV of from 30-90 and comprises not more than 80% of a saturated or unsaturated, branched or unbranched alkyl group having from 16 to 18 carbon atoms, and mixtures thereof, the remainder of R being selected from saturated or unsaturated, branched or straight-chain alkyl groups having from about 6 to about 26 carbon atoms.

9. The composition of claim 1 wherein said composition comprises from about 1% to about 10% by weight of said amido alkyl amine quaternary ammonium compound.

10. The composition of claim 1 wherein the weight ratio of anionic surfactant component to amido alkyl amine quaternary ammonium compound is from about 1:1 to about 20:1.

11. The composition of claim 1 wherein said detersive surfactant is an anionic surfactant.

12. The composition of claim 11 wherein said anionic surfactant comprises water-soluble salts of alkyl sulfates, paraffin sulfonates containing from about 8 to about 24 carbon atoms; alkyl glyceryl ether sulfonates, esters of α-sulfonated fatty acids, olefin sulfonates containing from about 12 to 24 carbon atoms; β-alkyloxy alkane sulfonates containing from about 1 to 3 carbon atoms in the alkyl group and from about 8 to 20 carbon atoms in the alkane moiety, non-ethoxylated C₁₂₋₁₅ primary and secondary alkyl sulfates, alkyl benzene sulfonates, and mixtures thereof.

13. The composition of claim 12 wherein said anionic surfactant is a water-soluble alkyl sulfate and alkyl polyethoxylate sulfate of the formula
RO(C₂H₄O)x SO₃⁻M⁺
wherein R is a saturated or unsaturated alkyl chain having from about 10 to about 22 carbon atoms, M is a cation, and x is from 0 to about 15.

14. The composition of claim 13 wherein said laundry detergent composition comprises from about 5 to 40% by weight of said detersive surfactant.

15. A 2-in-1 laundry detergent composition having improved softening and anti-static properties comprising at least one anionic detersive surfactant component and at least one softening agent compound, wherein said softening agent comprises at least one compound of the formula: 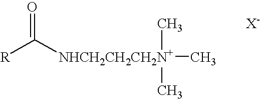
wherein R comprises not more than 80% of a saturated or unsaturated, branched or unbranched alkyl group having from 16 to 18 carbon atoms, and mixtures thereof, the remainder of R being selected from saturated or unsaturated, branched or straight-chain alkyl groups having from about 6 to about 26 carbon atoms, and wherein the IV of said R is from 20-10.

16. The composition of claim 15 which comprises from about 5 to 40% by weight of said detersive surfactant and from 1% to about 10% by weight of said softening agent.

17. The composition of claim 16 wherein the weight ratio of said detersive surfactant to said softening agent is from about 1:1 to about 20:1.

18. The composition of claim 8 wherein the IV of said R group is from 45 to 65.
